(19) United States
(12) Patent Application Publication
(10) Pub. No.: US 2024/0256906 A1
(43) Pub. Date: Aug. 1, 2024

(54) LEARNING TO COMBINE EXPLICIT DIVERSITY CONDITIONS FOR EFFECTIVE QUESTION ANSWER GENERATION

(71) Applicant: Samsung Electronics Co., Ltd., Suwon-si (KR)

(72) Inventors: Vikas Yadav, San Jose, CA (US); Hyuk Joon Kwon, New York, NY (US); Vijay Srinivasan, San Jose, CA (US); Hongxia Jin, San Jose, CA (US)

(21) Appl. No.: 18/401,074

(22) Filed: Dec. 29, 2023

Related U.S. Application Data
(60) Provisional application No. 63/441,527, filed on Jan. 27, 2023.

(51) Int. Cl. G06N 5/02; G06F 40/295

(52) U.S. Cl. CPC G06N 5/02; G06F 40/295

(57) ABSTRACT

A method includes predicting, using the at least one processing device, a question type for each section of a document using a trained question type prediction model, each section including a different portion of the document. The method also includes generating, using the at least one processing device, multiple question-answer pairs using a trained question-answer generation model that receives the predicted question types and the document as input. Each question-answer pair includes (i) a question having a type corresponding to one of the predicted question types and being associated with content in the section corresponding to the type and (ii) an answer to the question. The method further includes outputting, using the at least one processing device, the question-answer pairs for use in training a question answering model.

### CROSS-REFERENCE TO RELATED APPLICATION AND PRIORITY CLAIM

This application claims priority under 35 U.S.C. § 119(e) to U.S. Provisional Patent Application No. 63/441,527 filed on Jan. 27, 2023, which is hereby incorporated by reference in its entirety.

### TECHNICAL FIELD

This disclosure relates generally to natural language processing. More specifically, this disclosure relates to a system and method for learning to combine explicit diversity conditions for effective question answer generation.

### BACKGROUND

Question Answer Generation (QAG) is an effective data augmentation technique to improve the accuracy of question answering systems, especially in low-resource domains. QAG systems typically generate multiple sets of question-answer (QA) pairs given a context (such as a paragraph or document). Although recent pretrained and large language model-based QAG methods have made significant progress, they continue to exhibit various problems.

### SUMMARY

This disclosure provides a system and method for learning to combine explicit diversity conditions for effective question answer generation.

In a first embodiment, a method includes predicting, using at least one processing device of an electronic device, a question type for each section of a document using a trained question type prediction model, each section including a different portion of the document. The method also includes generating, using the at least one processing device, multiple question-answer pairs using a trained question-answer generation model that receives the predicted question types and the document as input. Each question-answer pair includes (i) a question having a type corresponding to one of the predicted question types and being associated with content in the section corresponding to the type and (ii) an answer to the question. The method further includes outputting, using the at least one processing device, the question-answer pairs for use in training a question answering model. In some aspects of the first embodiment, the trained question-answer generation model also receives position and entity information as input.

In a second embodiment, an electronic device includes at least one processing device configured to predict a question type for each section of a document using a trained question type prediction model, each section including a different portion of the document. The at least one processing device is also configured to generate multiple question-answer pairs using a trained question-answer generation model that receives the predicted question types and the document as input. Each question-answer pair includes (i) a question having a type corresponding to one of the predicted question types and being associated with content in the section corresponding to the type and (ii) an answer to the question. The at least one processing device is further configured to output the question-answer pairs for use in training a question answering model. In some aspects of the second embodiment, the trained question-answer generation model also receives position and entity information as input.

In a third embodiment, a non-transitory machine-readable medium contains instructions that when executed cause at least one processor of an electronic device to predict a question type for each section of a document using a trained question type prediction model, each section including a different portion of the document. The non-transitory machine-readable medium also contains instructions that when executed cause the at least one processor to generate multiple question-answer pairs using a trained question-answer generation model that receives the predicted question types and the document as input. Each question-answer pair includes (i) a question having a type corresponding to one of the predicted question types and being associated with content in the section corresponding to the type and (ii) an answer to the question. The non-transitory machine-readable medium further contains instructions that when executed cause the at least one processor to output the question-answer pairs for use in training a question answering model. In some aspects of the third embodiment, the trained question-answer generation model also receives position and entity information as input.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A. (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to,” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME. APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example process for generating diverse question answer pairs according to this disclosure;

FIG. 3 illustrates an excerpt of an example input document for the process of FIG. 2 according to this disclosure;

FIG. 4 illustrates various example question-answer (QA) pairs generated by a Q/A generator in the process of FIG. 2 according to this disclosure;

FIGS. 5 and 6 illustrate additional example QA pairs generated by the Q/A generator in the process of FIG. 2 according to this disclosure;

FIGS. 7 through 9 illustrate other example processes for generating diverse question answer pairs according to this disclosure; and

FIG. 10 illustrates an example method for generating diverse question answer pairs according to this disclosure.

### DETAILED DESCRIPTION

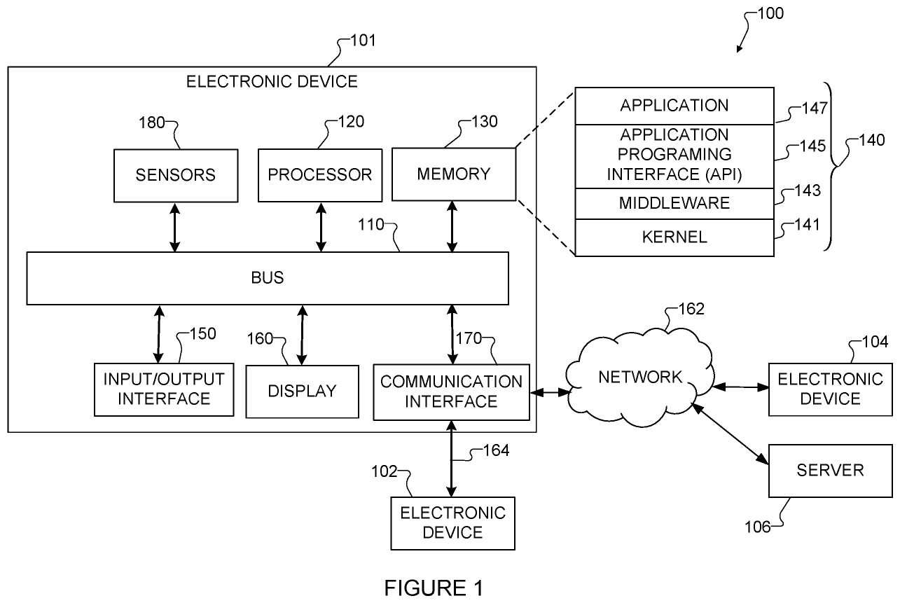

FIGS. 1 through 10, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, Question Answer Generation (QAG) is an effective data augmentation technique to improve the accuracy of question answering systems, especially in low-resource domains. QAG systems typically generate multiple sets of question-answer (QA) pairs given a context (such as a paragraph or document). Although recent pretrained and large language model-based QAG methods have made significant progress, they continue to exhibit various problems. For example, conventional techniques like diverse sampling and diverse beam searching with pretrained language models (PLMs) generate redundant and similar QA pairs. This leads to the problem of poor diversity in the generated synthetic QA dataset, which results in lower downstream QA performance when a QA model is trained using the dataset. Sampling and diverse beam searching techniques also often lead to low diversity QA pairs. For instance, such techniques often generate questions from a specific section of the input document or only generate certain types of questions (such as “what” questions or “why” questions). These techniques do not cover multiple plausible question types, positions, and entities from the input document.

This disclosure provides various techniques for learning to combine explicit diversity conditions for effective question answer generation. As described in more detail below, the disclosed embodiments feature conditioning techniques for diverse and controllable QA pair generation. For example, explicit conditions may be used to enable improved control in spatial diversity, question type diversity, and entity diversity when generating QA pairs. This leads to much higher diversity in QA generation. The disclosed embodiments can also combine explicit conditions, such as to search for all plausible diverse QA pairs from the input document, which maximizes the coverage of the document information. The diverse and high-quality synthetic QA-generated data from the disclosed techniques leads to substantial improvements in the diversity of question answer generation and coverage of information, as well as substantial improvements in downstream QA performance.

Note that while some of the embodiments discussed below are described in the context of use in consumer electronic devices (such as televisions and smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform one or more operations for learning to combine explicit diversity conditions for effective question answer generation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for learning to combine explicit diversity conditions for effective question answer generation as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180) can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an AR wearable device, such as a headset with a display panel or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below; the server 106 may perform one or more operations to support techniques for learning to combine explicit diversity conditions for effective question answer generation.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

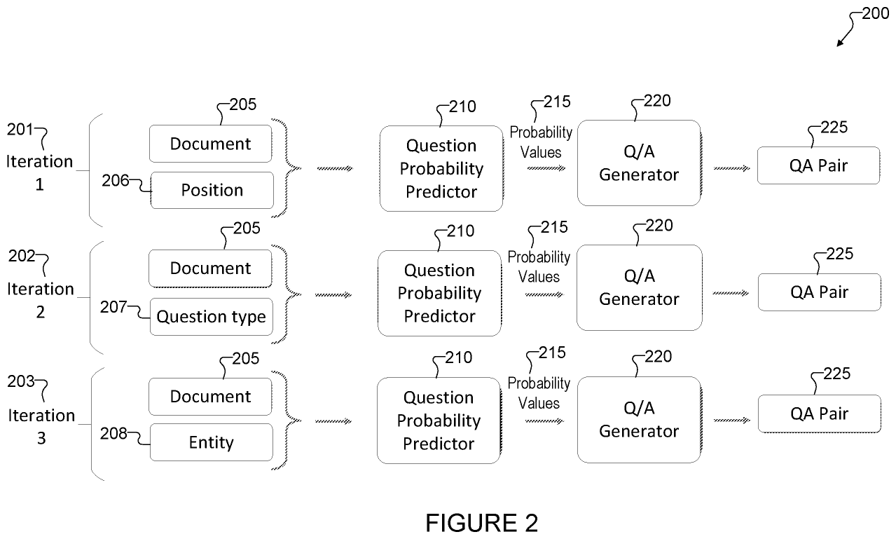

FIG. 2 illustrates an example process 200 for generating diverse question answer pairs according to this disclosure. For ease of explanation, the process 200 is described as being implemented using one or more components of the network configuration 100 of FIG. 1 described above, such as the server 106. However, this is merely one example, and the process 200 could be implemented using any other suitable device(s) (such as the electronic device 101) and in any other suitable system(s).

As shown in FIG. 2, the server 106 performs the process 200 in multiple iterations 201-203, where each iteration 201-203 is adapted for a different aspect of a document 205 that is provided as input data for the process 200. The document 205 represents any suitable collection and amount of text. The document 205 may be obtained from any suitable source(s). For example, in some embodiments, the document 205 is obtained from a commercially-available dataset, such as the Stanford Question Answering Dataset (SQUAD). In other embodiments, the document 205 is obtained from a website or other Internet source. In still other embodiments, the document 205 is generated using an artificial intelligence (AI) tool. Note that the document 205 may contain non-text elements, such as pictures, graphs, drawings, and the like. However, in some embodiments, the process 200 uses the text portion of the document 205 and may ignore any non-text elements of the document 205.

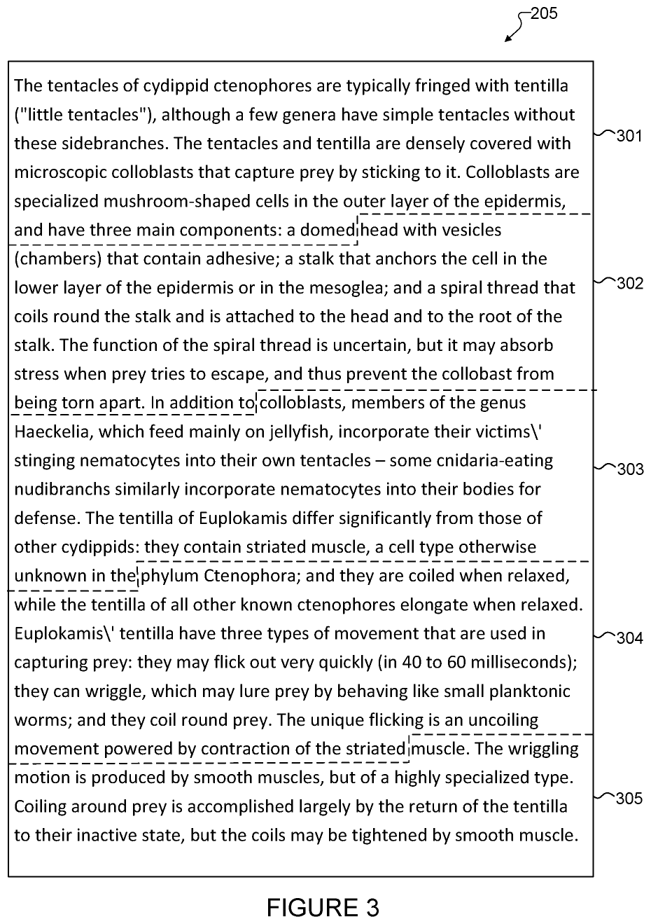

FIG. 3 illustrates an excerpt of an example document 205 according to this disclosure. In this particular example, the document 205 is obtained from the SQUAD dataset. As shown in FIG. 3, the document 205 is divided into multiple sections 301-305, where each section 301-305 includes a different portion of the document 205. In some embodiments, the server 106 divides the document 205 into sections as part of the process 200. In other embodiments, the document 205 is divided at an earlier time. While FIG. 3 shows the document 205 divided into five sections 301-305, there is merely one example, and this document 205 or other documents can be divided into more or fewer sections.

In the iteration 201, the server 106 provides the document 205 and position information 206 as input to a question probability predictor 210. Here, the position information 206 identifies the different sections into which the document 205 is divided. For the example shown in FIG. 3, the position information 206 could include an identification of the five sections 301-305 of the document 205 (such as POS∈{1,2,3,4,5}).

The question probability predictor 210 represents or includes a deep learning model, such as a large language model (LLM) or a pretrained language model (PLM). The question probability predictor 210 is trained to examine a document 205 and determine whether it is possible to generate questions and answers from the document (or one or more portions thereof) and, if so, to determine a corresponding probability of generating the questions and answers. In this example, the question probability predictor 210 receives the document 205 and the position information 206 and predicts whether it is possible to generate a QA pair from the text of each section 301-305 of the document 205 indicated by the position information 206. In other words, using the example of FIG. 3, the question probability predictor 210 predicts whether it is possible to generate a QA pair from the text of section 301 (POS=1), whether it is possible to generate a QA pair from the text of section 302 (POS=2), whether it is possible to generate a QA pair from the text of section 303 (POS=3), whether it is possible to generate a QA pair from the text of section 304 (POS=4), and whether it is possible to generate a QA pair from the text of section 305 (POS=5). In some embodiments, the question probability predictor 210 can generate a probability value 215 for each section 301-305 indicating the likelihood that a QA pair can be generated from that section 301-305. In some embodiments, the probability values 215 can be represented as QA˜P(qa|D, POS), where D represents the document 205 and POS∈{1, 2, 3, 4, 5} represents the position information 206.

When a probability value 215 for a particular section 301-305 is greater than a threshold value, this is an indication that a QA pair is likely to be generated from the text of that section 301-305. Accordingly, when the probability value 215 is greater than the threshold value, the server 106 provides the document 205 and a prompt indicating the position information 206 of the corresponding section 301-305 of the document 205 as input to a Q/A generator 220. The Q/A generator 220 is a question-answer generation model, such as an LLM or a PLM, that is trained to generate a QA pair from text that is received as input. For each prompt that is input to the Q/A generator 220, the Q/A generator 220 attempts to generate a QA pair 225 based on the text of the corresponding section 301-305.

As an example, assume that the probability values 215 for sections 301 and 303 are greater than the threshold value. Using this assumption, the server 106 can provide the document 205 and a prompt such as “Generate a QA pair from POS=1” to the Q/A generator 220, and the Q/A generator 220 can attempt to generate a QA pair 225 from the text of section 301. The server 106 can also provide the document 205 and another prompt such as “Generate a QA pair from POS=3” to the Q/A generator 220, and the Q/A generator 220 can attempt to generate a QA pair 225 from the text of section 303. Thus, as can be seen here, the Q/A generator 220 receives the prompts and attempts to generate a QA pair 225 for each of the sections 301-305 having a probability value 215 that is greater than the threshold value. When the probability value 215 is less than the threshold value, this is an indication that a QA pair is not likely to be generated from the text of that section 301-305, and the server 106 may not provide a prompt for that section 301-305 as input to the Q/A generator 220.

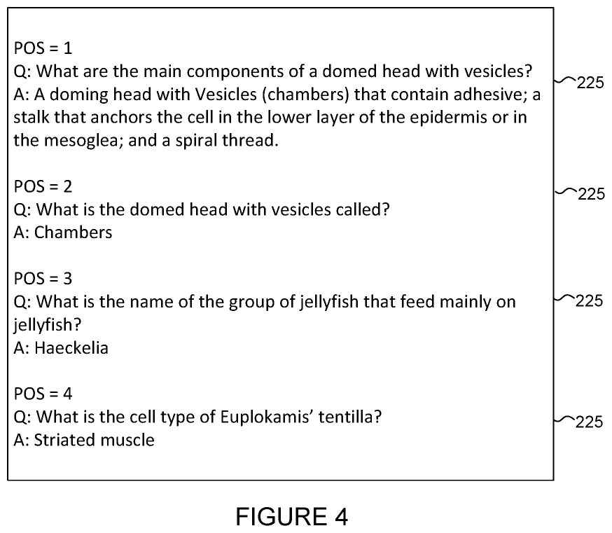

FIG. 4 illustrates various example QA pairs 225 generated by the Q/A generator 220 according to this disclosure. As shown in FIG. 4, the Q/A generator 220 generates QA pairs 225 from four different sections 301-304 of the document 205. Because the QA pairs 225 are generated from different sections 301-304 of the document 205, the QA pairs 225 can exhibit greater diversity than is possible or likely with conventional QA generation techniques.

In the iteration 202, the server 106 provides the document 205 and a question type 207 as input to the question probability predictor 210. Here, the question type 207 identifies a desired type of question to be generated by the Q/A generator 220. In some embodiments, the question type 207 identifies one of a set of question types that start with a WH-type word, such as WH∈{what, when, where, who, whom, which, whose, why, how, other}.

The question probability predictor 210 receives the document 205 and the question type 207 and predicts whether it is possible to generate a QA pair from the text of the document 205 so that the question of the QA pair is of the type identified by the question type 207. In other words, the question probability predictor 210 predicts whether it is possible to generate a “what” QA pair from the text of the document 205, whether it is possible to generate a “when” QA pair from the text of the document 205, whether it is possible to generate a “where” QA pair from the text of the document 205, and so on. In some embodiments, the question probability predictor 210 can generate a probability value 215 for each question type 207 indicating the likelihood that a QA pair of that question type 207 can be generated. In some embodiments, the probability values 215 can be represented as QA˜P(qa|D, WH), where D represents the document 205 and WH∈{what, when, where, who, whom, which, whose, why, how; other} represents the question type 207.

When a probability value 215 for a particular question type 207 is greater than a threshold value, this is an indication that a QA pair of that question type 207 is likely to be generated from the text of the document 205. Accordingly, when the probability value 215 is greater than the threshold value, the server 106 provides the document 205 and a prompt indicating the question type 207 as input to the Q/A generator 220. For each prompt that is input to the Q/A generator 220, the Q/A generator 220 attempts to generate a QA pair 225 of that question type 207 based on the text of the document 205.

As an example, assume that the probability values 215 for the “where” and “what” question types 207 are greater than the threshold value. Using this assumption, the server 106 can provide the document 205 and a prompt such as “Generate a ‘where’ QA pair” to the Q/A generator 220, and the Q/A generator 220 can attempt to generate a “where” QA pair 225 from the text of the document 205. The server 106 can also provide the document 205 and another prompt such as “Generate a ‘what’ QA pair” to the Q/A generator 220, and the Q/A generator 220 can attempt to generate a “what” QA pair 225 from the text of the document 205. Thus, as can be seen here, the Q/A generator 220 receives the prompts and attempts to generate a QA pair 225 for each of the question types 207 having a probability value 215 that is greater than the threshold value. When the probability value 215 is less than the threshold value, this is an indication that a QA pair of that question type 207 is not likely to be generated from the document 205, and the server 106 may not provide a prompt for that question type 207 as input to the Q/A generator 220.

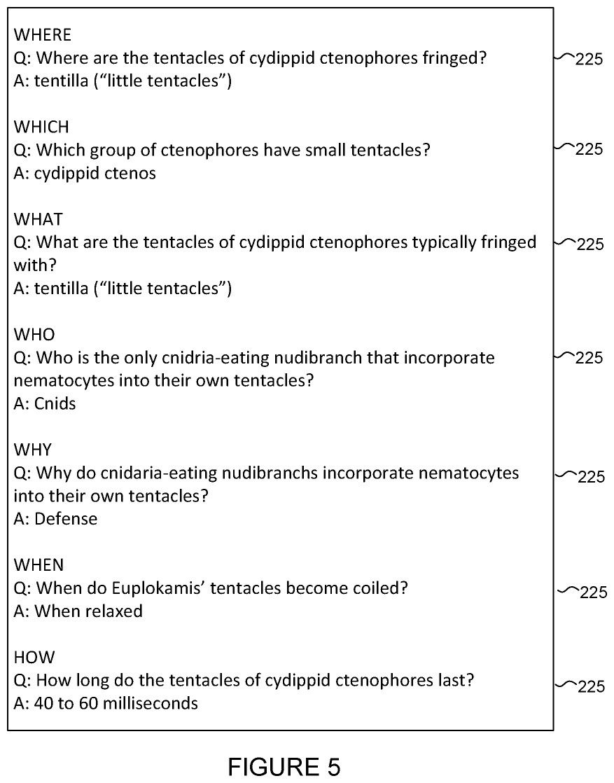

FIG. 5 illustrates additional example QA pairs 225 generated by the Q/A generator 220 according to this disclosure. As shown in FIG. 5, the Q/A generator 220 generates QA pairs 225 from seven different question types 207. With so many different types of questions, the QA pairs 225 can exhibit greater diversity than is possible or likely with conventional QA generation techniques.

In the iteration 203, the server 106 provides the document 205 and one or more entities 208 as input to the question probability predictor 210. Here, each entity 208 identifies a named entity that is extracted from the document 205 and can represent an element of the question to be generated by the Q/A generator 220. In some embodiments, the entities 208 can include proper nouns (such as names) or specific subjects. In the example document 205 shown in FIG. 3, for instance, some entities 208 include “epidermis,” “Haeckella,” and “Euplokamis.”

The question probability predictor 210 receives the document 205 and each entity 208 and predicts whether it is possible to generate a QA pair from the text of the document 205 so that the question of the QA pair includes the entity 208. For example, the question probability predictor 210 may predict whether it is possible to generate a QA pair related to “epidermis” from the text of the document 205, whether it is possible to generate a QA pair related to “Haeckella” from the text of the document 205, whether it is possible to generate a QA pair related to “Euplokamis” from the text of the document 205, and so on. In some embodiments, the question probability predictor 210 can generate a probability value 215 for each entity 208 indicating the likelihood that a QA pair including that entity 208 can be generated. In some embodiments, the probability values 215 can be represented as QA˜P(qa|D, ENT), where D represents the document 205 and ENT∈{“epidermis,” “Haeckella,” “Euplokamis,” . . . } represents the entity 208.

When a probability value 215 for a particular entity 208 is greater than a threshold value, this is an indication that a QA pair that includes that entity 208 is likely to be generated from the text of the document 205. Accordingly, when the probability value 215 is greater than the threshold value, the server 106 provides the document 205 and a prompt indicating the entity 208 as input to the Q/A generator 220. For each prompt that is input to the Q/A generator 220, the Q/A generator 220 attempts to generate a QA pair 225 of that entity 208 based on the text of the document 205.

As an example, assume that the probability values 215 for the “epidermis” and “Haeckella” entities 208 are greater than the threshold value. Using this assumption, the server 106 can provide the document 205 and a prompt such as “Generate a QA pair on epidermis” to the Q/A generator 220, and the Q/A generator 220 can attempt to generate an “epidermis” QA pair 225 from the text of the document 205. The server 106 can also provide the document 205 and another prompt such as “Generate a QA pair on Haeckella” to the Q/A generator 220, and the Q/A generator 220) can attempt to generate a “Haeckella” QA pair 225 from the text of the document 205. In some embodiments, during inferencing, the document 205 can be divided into individual sentences, and the server 106 can select the longest named entity from each sentence to use in the prompt. Thus, as can be seen here, the Q/A generator 220 receives the prompts and attempts to generate a QA pair 225 for each of the entities 208 having a probability value 215 that is greater than the threshold value. When the probability value 215 is less than the threshold value, this is an indication that a QA pair including that entity 208 is not likely to be generated from the document 205, and the server 106 may not provide a prompt for that entity 208 as input to the Q/A generator 220.

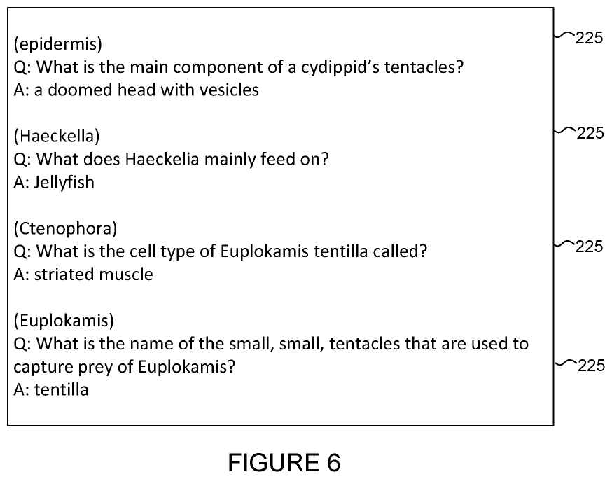

FIG. 6 illustrates additional example QA pairs 225 generated by the Q/A generator 220 according to this disclosure. As shown in FIG. 6, the Q/A generator 220 generates QA pairs 225 from four different entities 208. With so many different types of questions, the QA pairs 225 can exhibit greater diversity than is possible or likely with conventional QA generation techniques.

Once the QA pairs 225 are generated by the Q/A generator 220 in all three iterations 201-203, the server 106 can combine the QA pairs 225 into a single pool of questions and answers. For example, the server 106 can combine the QA pairs 225 shown in FIGS. 4, 5, and 6 into a single pool. The pool of QA pairs 225 can be output for use in training another model, such as a question answering model. In some embodiments, the server 106 can compare the QA pairs 225 to each other to search for any duplicate QA pairs 225 (or QA pairs 225 with lexical redundancy) and remove duplicate or redundant QA pairs 225 from the pool. In general, the QA pairs 225 from different iterations 201-203 can be lexically different from one another. In particular embodiments, the server 106 can determine a quality score for each QA pair 225. If the quality score for a QA pair 225 is less than a specified threshold, the server 106 can remove that QA pair 225 from the pool so that the QA pair 225 is not output or otherwise used.

The Q/A generator 220 can be implemented in various ways to generate QA pairs 225. For example, in some cases, the Q/A generator 220 can be trained in advance to generate QA pairs 225 for all three iterations 201-203. In other cases, different instances of the Q/A generator 220 can be uniquely trained to handle different iterations 201-203. The Q/A generator 220 may also be trained in any suitable manner. For instance, in some embodiments, the training of the Q/A generator 220 can use publicly-available QA training datasets, such as the SQUAD dataset. Human-annotated questions and answers generated from the training datasets can be provided as specific training examples. Also, in some embodiments, training of the Q/A generator 220 can include named entities and entity classes, such as those extracted from a publicly-available QA training dataset.

Although FIGS. 2 through 6 illustrate one example of a process 200 for generating diverse question answer pairs and related details, various changes may be made to FIGS. 2 through 6. For example, while the process 200 is described as involving specific sequences of operations, various operations described with respect to FIG. 2 could overlap, occur in parallel, occur in a different order, or occur any number of times (including zero times). Also, the specific operations shown in FIG. 2 are examples only, and other techniques could be used to perform each of the operations shown in FIG. 2. In addition, the examples shown in FIGS. 3 through 6 are for illustration and explanation only and do not limit this disclosure to any specific input documents or QA.

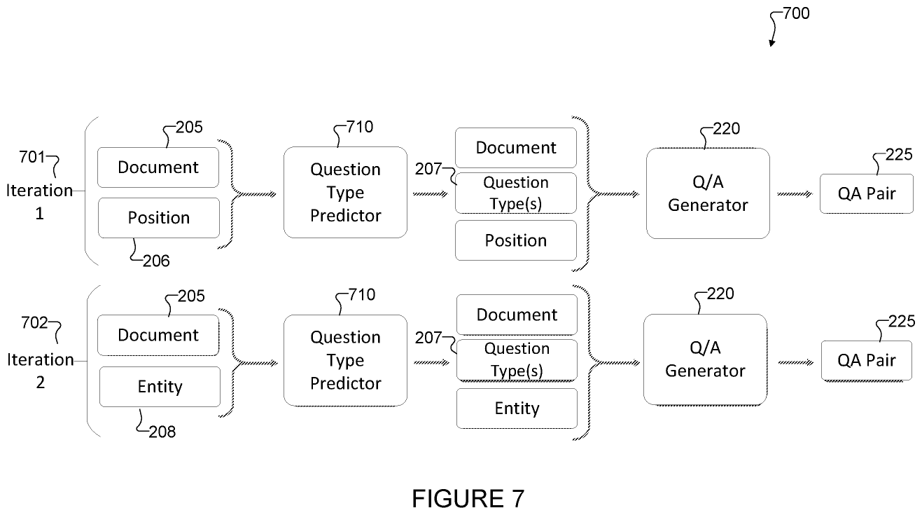

FIG. 7 illustrates another example process 700 for generating diverse question answer pairs according to this disclosure. For ease of explanation, the process 700 is described as being implemented using one or more components of the network configuration 100 of FIG. 1 described above, such as the server 106. However, this is merely one example, and the process 700 could be implemented using any other suitable device(s) (such as the electronic device 101) and in any other suitable system(s).

As shown in FIG. 7, the process 700 includes multiple components that may be the same as or similar to corresponding components in the process 200 of FIG. 2. The server 106 performs the process 700 in multiple iterations 701 and 702, where each iteration 701 and 702 is adapted for a different combination of aspects of the document 205 provided as input data for the process 700.

In the iteration 701, the server 106 provides the document 205 and position information 206 as input to a question type predictor 710. The question type predictor 710 is a deep learning model, such as an LLM or a PLM, that is trained to examine a document and determine which question types 207 are plausible for a given condition so as to be able to generate questions and answers for those question types 207. Specifically, in the iteration 701, the given condition is the position information 206. The question type predictor 710 generates a list of question types 207 that are good candidates for QA pairs 225 from each section 301-305 of the document 205.

Using the document 205 of FIG. 3 as an example, the question type predictor 710 could predict, for example, that at least one “where” QA pair 225, at least one “what” QA pair 225, and at least one “how” QA pair 225 are likely to be generated from the text of section 301 (POS=1) of the document 205. Thus, the generated list of question types 207 for POS=1 is {“where”, “what”, “how”}. The question type predictor 710 could also predict, for example, that at least one “where” QA pair 225 and at least one “who” QA pair 225 are likely to be generated from the text of section 302 (POS=2). Thus, the generated list of question types 207 for POS=2 is {“where”, “who”}. The question type predictor 710 could further predict, for example, that no QA pairs 225 of any question type 207 are likely to be generated from the text of section 303 (POS=3). Thus, the generated list of question types 207 for POS=3 is { } (such as a null list).

Using the output of the question type predictor 710, the server 106 provides the document 205, the position information 206, and the corresponding list of question types 207 as joint condition prompts to the Q/A generator 220. For each prompt that is input to the Q/A generator 220, the Q/A generator 220 attempts to generate a QA pair 225 from the text of the section 301-305 corresponding to the position information 206 and that is of the question type 207. For example, for section 302 (POS=2), if the question type predictor 710 generates a {“where”, “who”} list, the Q/A generator 220 generates at least two QA pairs 225 from section 302 with “where” and “who” question types 207.

In the iteration 702, the server 106 provides the document 205 and one or more entities 208 as input to the question type predictor 710. The question type predictor 710 generates a list of question types 207 that are good candidates for QA pairs 225 that include one of the entities 208. Using the output of the question type predictor 710, the server 106 provides the document 205, the entities 208, and the corresponding list of question types 207 as joint condition prompts to the Q/A generator 220. For each prompt that is input to the Q/A generator 220, the Q/A generator 220 attempts to generate a QA pair 225 from the text of the document 205 corresponding to the entity 208 and that is of the question type 207.

Once the QA pairs 225 are generated by the Q/A generator 220 in both iterations 701 and 702, the server 106 can combine the QA pairs 225 into a single pool of questions and answers. The pool of QA pairs 225 can be output for use in training another model, such as a question answering model. In some embodiments, the server 106 can compare the QA pairs 225 to each other to search for any duplicate QA pairs 225 (or QA pairs 225 with lexical redundancy) and remove duplicate or redundant QA pairs 225 from the pool. In general, the QA pairs 225 from the iterations 701-702 can be lexically different from one another. In particular embodiments, the server 106 can determine a quality score for each QA pair 225. If the quality score for a QA pair 225 is less than a specified threshold, the server 106 can remove that QA pair 225 from the pool so that the QA pair 225 is not output or otherwise used.

In some embodiments, the processes 200 and 700 can be performed as part of a single process to generate QA pairs 225. In such embodiments, the QA pairs 225 generated in the process 200 and the QA pairs generated in the process 700 can be combined into a single combined pool of questions and answers. Also, in some embodiments, the server 106 can search this combined pool for lexical redundancy and remove redundant QA pairs 225 from the pool.

Again, the Q/A generator 220 can be implemented in various ways to generate QA pairs 225. For example, in some cases, the Q/A generator 220 can be trained in advance to generate QA pairs 225 for both iterations 701 and 702. In other cases, different instances of the Q/A generator 220 can be uniquely trained to handle different iterations 701-702. The Q/A generator 220 may also be trained in any suitable manner. For instance, in some embodiments, the training of the Q/A generator 220 can use publicly-available QA training datasets, such as the SQUAD dataset. Human-annotated questions and answers generated from the training datasets can be provided as specific training examples. Also, in some embodiments, training of the Q/A generator 220 can include named entities and entity classes, such as those extracted from a publicly-available QA training dataset.

Although FIG. 7 illustrates another example of a process 700 for generating diverse question answer pairs and related details, various changes may be made to FIG. 7. For example, while the process 700 is described as involving specific sequences of operations, various operations described with respect to FIG. 7 could overlap, occur in parallel, occur in a different order, or occur any number of times (including zero times). Also, the specific operations shown in FIG. 7 are examples only, and other techniques could be used to perform each of the operations shown in FIG. 7. For instance, the generation of question types 207 for both position information 206 and entities 208 could be performed in a single iteration instead of multiple separate iterations 701 and 702. In this case, the iterations 701 and 702 would be merged into a single pass using an LLM-based question type predictor 710.

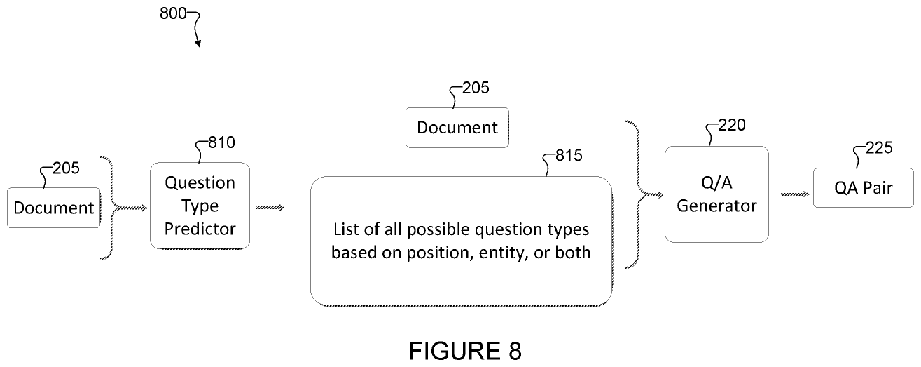

FIG. 8 illustrates yet another example process 800 for generating diverse question answer pairs according to this disclosure. For ease of explanation, the process 800 is described as being implemented using one or more components of the network configuration 100 of FIG. 1 described above, such as the server 106. However, this is merely one example, and the process 800 could be implemented using any other suitable device(s) (such as the electronic device 101) and in any other suitable system(s).

As shown in FIG. 8, the process 800 includes multiple components that may be the same as or similar to corresponding components in the process 200 of FIG. 2. However, the process 800 can be performed in a single pass, meaning multiple iterations may not be performed. In the process 800, the server 106 provides the document 205 to a question type predictor 810. The question type predictor 810 is a deep learning model, such as an LLM or a PLM, that is trained to examine a document and determine which question types 207 are possible for the document so as to be able to generate questions and answers for those question types 207. Here, the question types 207 are related to position information 206, entities 208, or both. The question type predictor 810 is trained to generate a list 815 of possible question types 207 using just the document 205 as input.

Using the document 205 of FIG. 3 as an example, the question type predictor 810 could make the following predictions. For section 301 (POS=1) and a first entity 208 (ENT=1), a “what” QA pair 225 is possible. For section 301 (POS=1), a “when” QA pair 225 is possible. For section 301 (POS=1) and a second entity 208 (ENT=2), a “where” QA pair 225 is possible. For section 303 (POS=3) and a fifth entity 208 (ENT=5), a “why” QA pair 225 is possible. For an eighth entity 208 (ENT=8), a “when” QA pair 225 is possible. For section 305 (POS=5), a “who” QA pair 225 is possible. In some cases, this may continue so that all possible question types 207 are determined for all possible combinations of position information 206 (POS), entity 208 (ENT), or both position information 206 and entity 208 (POS+ENT) in the document 205. Thus, as can be seen here, the server 106 provides the document 205 and the list 815 of all possible question types 207 as joint condition prompts to the Q/A generator 220 using the output of the question type predictor 810. For each prompt that is input to the Q/A generator 220, the Q/A generator 220 attempts to generate a QA pair 225 from the text of the document 205 and that corresponds to the set of question type 207, position 206, and entity 208 in the prompt.

Once the QA pairs 225 are generated by the Q/A generator 220, the server 106 can combine the QA pairs 225 into a single pool of questions and answers. The pool of QA pairs 225 can be output for use in training another model, such as a question answering model. In some embodiments, the server 106 can compare the QA pairs 225 to each other to search for any duplicate QA pairs 225 (or QA pairs 225 with lexical redundancy) and remove duplicate or redundant QA pairs 225 from the pool. In particular embodiments, the server 106 can determine a quality score for each QA pair 225. If the quality score for a QA pair 225 is less than a specified threshold, then the server 106 can remove that QA pair 225 from the pool so that the QA pair 225 is not output or otherwise used.

In some embodiments, the process 800 can be used in conjunction with one or both of the processes 200 and 700 as part of a single process to generate QA pairs 225. In such embodiments, the QA pairs 225 generated in the processes 200 and/or 700 and 800 can be combined into a single combined pool of questions and answers. In some embodiments, the server 106 can search this combined pool for lexical redundancy and remove redundant QA pairs 225 from the pool.

Again, the Q/A generator 220 can be implemented in various ways to generate QA pairs 225. For example, in some cases, the Q/A generator 220 can be trained in advance to generate QA pairs 225. The Q/A generator 220 may also be trained in any suitable manner. For instance, in some embodiments, the training of the Q/A generator 220 can use publicly-available QA training datasets, such as the SQUAD dataset. Human-annotated questions and answers generated from the training datasets can be provided as specific training examples. Also, in some embodiments, training of the Q/A generator 220 can include named entities and entity classes, such as those extracted from a publicly-available QA training dataset.

Although FIG. 8 illustrates yet another example of a process 800 for generating diverse question answer pairs and related details, various changes may be made to FIG. 8. For example, while the process 800 is described as involving specific sequences of operations, various operations described with respect to FIG. 8 could overlap, occur in parallel, occur in a different order, or occur any number of times (including zero times). Also, the specific operations shown in FIG. 8 are examples only, and other techniques could be used to perform each of the operations shown in FIG. 8.

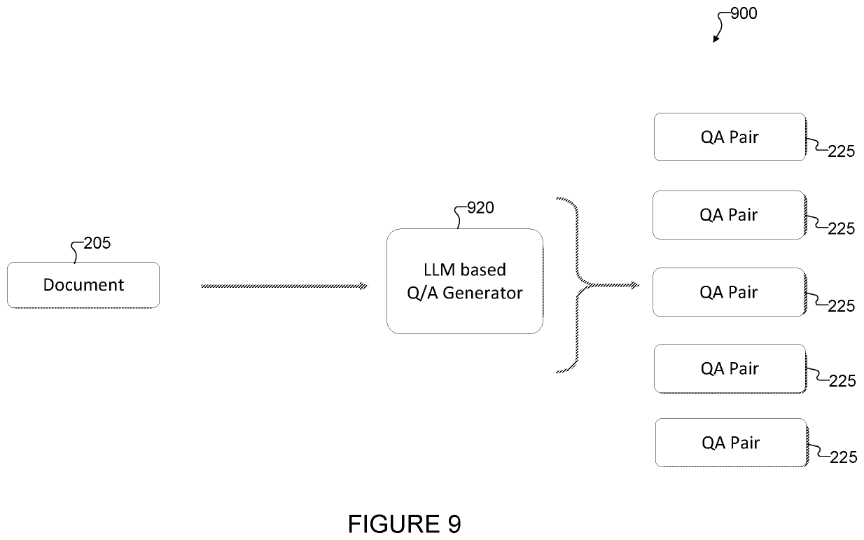

FIG. 9 illustrates still another example process 900 for generating diverse question answer pairs according to this disclosure. For ease of explanation, the process 900 is described as being implemented using one or more components of the network configuration 100 of FIG. 1 described above, such as the server 106. However, this is merely one example, and the process 900 could be implemented using any other suitable device(s) (such as the electronic device 101) and in any other suitable system(s).

As shown in FIG. 9, the process 900 uses a Q/A generator 920 to generate multiple QA pairs 225 from an input document 205. Here, the Q/A generator 920 can be an instruction fined-tuned (IFT) LLM that is trained to generate diverse QA pairs from a document 205. In the process 900, the server 106 can prompt the Q/A generator 920 with combinations of diversity conditions, such as combinations of position information 206, question type 207, and entity 208. Once prompted, the Q/A generator 920 can generate multiple QA pairs 225 in a single pass.

The Q/A generator 920 can be implemented in various ways to generate QA pairs 225. For example, in some cases, the Q/A generator 920 can be trained in advance to generate QA pairs 225. The Q/A generator 920 may also be trained in any suitable manner. For instance, in some embodiments, the training of the Q/A generator 920 can use publicly-available QA training datasets, such as the SQUAD dataset. Human-annotated questions and answers generated from the training datasets can be provided as specific training examples. In some embodiments, training can include adding one or more prompts such as “Generate N diverse QA pairs from the input document maximizing diversity of WH, POS. ENT” along with the training document 205. During inferencing, the server 106 can select any value of N to generate N diverse QA pairs 225. Also, in some embodiments, training of the Q/A generator 920 can include named entities and entity classes, such as those extracted from a publicly-available QA training dataset.

Although FIG. 9 illustrates still another example of a process 900 for generating diverse question answer pairs and related details, various changes may be made to FIG. 9. For example, while the process 900 is described as involving specific sequences of operations, various operations described with respect to FIG. 9 could overlap, occur in parallel, occur in a different order, or occur any number of times (including zero times). Also, the specific operations shown in FIG. 9 are examples only, and other techniques could be used to perform each of the operations shown in FIG. 9.

As discussed above, in some embodiments, the document 205 can include elements other than text. For example, in some embodiments, the document 205 can include one or more tables having rows and columns of information. In such embodiments, different types of QA pairs 225 can be generated for each row or column of a given table. Here, the explicit diversity conditions can refer to different columns or rows from the table, entities, or cells in the table. For some complex documents 205 that include passages, tables, diagrams, and the like, a “multi-hop” QA pair generation process can combine position information 206, question type 207, and entity 208 from different passages, passages and tables, passages and diagrams, tables and diagrams, and any other suitable combination of document elements.

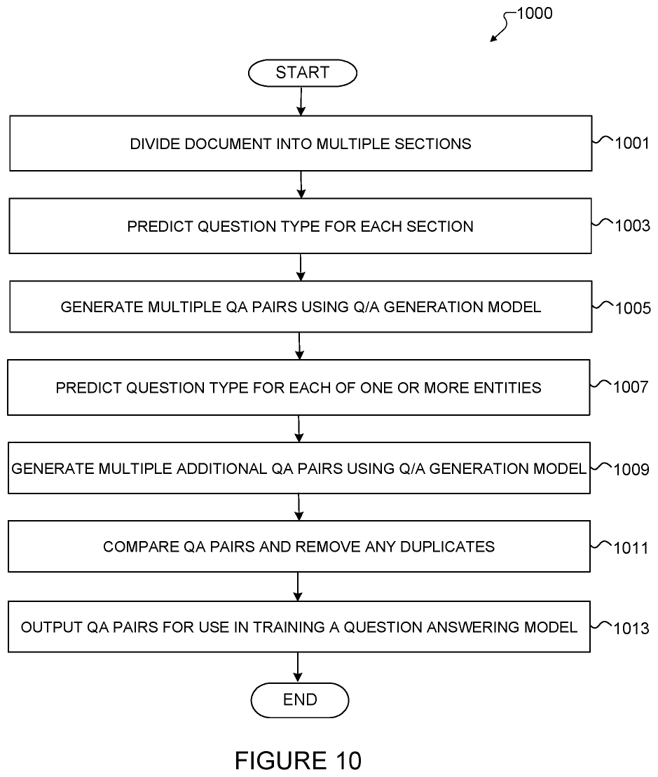

FIG. 10 illustrates an example method 1000 for generating diverse question answer pairs according to this disclosure. For ease of explanation, the method 1000 shown in FIG. 10 is described as being performed using the server 106 shown in FIG. 1 and the process 700 shown in FIG. 7. However, the method 1000 shown in FIG. 10 could be used with any other suitable device(s) or system(s) and could be used to perform any other suitable process(es) (such as the process 200 or 800).

As shown in FIG. 10, at step 1001, a document is divided into multiple sections, where each section includes a different portion of the document. This could include, for example, the server 106 dividing the document 205 into sections 301-305, such as is shown in FIG. 3. At step 1003, a question type for each of the sections is predicted using a trained question type prediction model. This could include, for example, the server 106 using the question type predictor 710 to predict one or more question types 207 in iteration 701, such as shown in FIG. 7.

At step 1005, multiple question-answer pairs are generated using a trained question-answer generation model that receives the predicted question types and the document as input. Each question-answer pair includes (i) a question having a type corresponding to one of the predicted question types and being associated with content in the section corresponding to the type and (ii) an answer to the question. This could include, for example, the server 106 using the Q/A generator 220 to generate multiple QA pairs 225, such as shown in FIG. 7. At step 1007, a question type for each of one or more entities is predicted using the question type prediction model. This could include, for example, the server 106 using the question type predictor 710 to predict one or more entities 208 in iteration 702, such as shown in FIG. 7.

At step 1009, multiple additional question-answer pairs are generated using the question-answer generation model, which receives the document and the question type for each of the one or more entities. This could include, for example, the server 106 using the Q/A generator 220 to generate multiple additional QA pairs 225, such as shown in FIG. 7. At step 1011, the question-answer pairs are compared to each other to determine any duplicate question-answer pairs, which can be removed. This could include, for example, the server 106 comparing the QA pairs 225 to each other to determine and remove any duplicate QA pairs 225. At step 1013, the question-answer pairs are output for use in training a question answering model. This could include, for example, the server 106 outputting the QA pairs 225 for use in training a question answering model.

Although FIG. 10 illustrates one example of a method 1000 for generating diverse question answer pairs, various changes may be made to FIG. 10. For example, while shown as a series of steps, various steps in FIG. 10 could overlap, occur in parallel, occur in a different order, or occur any number of times (including zero times).

The embodiments described above can provide multiple advantageous benefits. For example, compared to conventional diversity sampling and beam-search based techniques, the disclosed embodiments provide a significant improvement in diversity of generated QA pairs, which can lead to improved downstream QA performance, especially in low resource domains. Additionally, the disclosed embodiments provide improved control of QA pair generation. For example, the disclosed embodiments enable the generation of QA pairs from any position of the input document, any question type, and any entity. In addition, the QA pairs generated using the disclosed embodiments comprehensively cover the information present in the input document by utilizing all three diversity aspects—position, question type, and entity.

The disclosed embodiments are suitable for a wide variety of use cases. For instance, the disclosed embodiments enable the implementation of electronic trivia chatbots, such as those that operate on a television or smartphone, by generating questions and answers from input media. The disclosed embodiments also facilitate operation of personal voice assistants (such as BIXBY) by generating high quality synthetic QA data for making such voice assistants more robust in low resource domains or languages. The disclosed embodiments can also be employed in customer service bots, automatic frequency asked question (FAQ) generation, and educational and testing scenarios.

Note that the operations and functions shown in or described with respect to FIGS. 2 through 10 can be implemented in an electronic device 101, 102, 104, server 106, or other device(s) in any suitable manner. For example, in some embodiments, the operations and functions shown in or described with respect to FIGS. 2 through 10 can be implemented or supported using one or more software applications or other software instructions that are executed by the processor 120 of the electronic device 101, 102, 104, server 106, or other device(s). In other embodiments, at least some of the operations and functions shown in or described with respect to FIGS. 2 through 10 can be implemented or supported using dedicated hardware components. In general, the operations and functions shown in or described with respect to FIGS. 2 through 10 can be performed using any suitable hardware or any suitable combination of hardware and software/firmware instructions.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
predicting, using at least one processing device of an electronic device, a question type for each section of a document using a trained question type prediction model, each section including a different portion of the document;
generating, using the at least one processing device, multiple question-answer pairs using a trained question-answer generation model that receives the predicted question types and the document as input, each question-answer pair comprising (i) a question having a type corresponding to one of the predicted question types and being associated with content in the section corresponding to the type and (ii) an answer to the question; and
outputting, using the at least one processing device, the question-answer pairs for use in training a question answering model.

2. The method of claim 1, wherein the type of the question in each question-answer pair indicates that the associated question starts with one of: what, when, where, who, whom, which, whose, why, or how.

3. The method of claim 1, wherein the question type prediction model is trained to predict one or more question types for the document based on one or more entities described in the document.

4. The method of claim 3, further comprising:
predicting a question type for each of the one or more entities using the question type prediction model;
inputting the document and the question type for each of the one or more entities to the question-answer generation model; and
generating multiple additional question-answer pairs using the question-answer generation model.

5. The method of claim 1, wherein:
the question type prediction model is trained to output a list of possible question types for possible combinations of section and entity for the document; and
generating the multiple question-answer pairs using the trained question-answer generation model comprises generating at least one question-answer pair for each of the possible combinations.

6. The method of claim 5, wherein:
each question-answer pair is associated with a quality score; and
a particular question-answer pair is not output if the quality score of the particular question-answer pair is less than a specified threshold.

7. The method of claim 1, further comprising:
comparing the question-answer pairs to each other to determine any duplicate question-answer pairs; and
removing one or more duplicate question-answer pairs before outputting the question-answer pairs.

8. The method of claim 1, wherein the question type prediction model and the question-answer generation model comprise large language models.

9. An electronic device comprising:
at least one processing device configured to:
predict a question type for each section of a document using a trained question type prediction model, each section including a different portion of the document;
generate multiple question-answer pairs using a trained question-answer generation model that receives the predicted question types and the document as input, each question-answer pair comprising (i) a question having a type corresponding to one of the predicted question types and being associated with content in the section corresponding to the type and (ii) an answer to the question; and
output the question-answer pairs for use in training a question answering model.

10. The electronic device of claim 9, wherein the type of the question in each question-answer pair indicates that the associated question starts with one of: what, when, where, who, whom, which, whose, why, or how.

11. The electronic device of claim 9, wherein the question type prediction model is trained to predict one or more question types for the document based on one or more entities described in the document.

12. The electronic device of claim 11, wherein the at least one processing device is further configured to:
predict a question type for each of the one or more entities using the question type prediction model;
input the document and the question type for each of the one or more entities to the question-answer generation model; and
generate multiple additional question-answer pairs using the question-answer generation model.

13. The electronic device of claim 9, wherein:
the question type prediction model is trained to output a list of possible question types for possible combinations of section and entity for the document; and
to generate the multiple question-answer pairs using the trained question-answer generation model, the at least one processing device is configured to generate at least one question-answer pair for each of the possible combinations.

14. The electronic device of claim 13, wherein:
each question-answer pair is associated with a quality score; and
the at least one processing device is configured to not output a particular question-answer pair if the quality score of the particular question-answer pair is less than a specified threshold.

15. The electronic device of claim 9, wherein the at least one processing device is further configured to:
compare the question-answer pairs to each other to determine any duplicate question-answer pairs; and
remove one or more duplicate question-answer pairs before outputting the question-answer pairs.

16. The electronic device of claim 9, wherein the question type prediction model and the question-answer generation model comprise large language models.

17. A non-transitory machine-readable medium containing instructions that when executed cause at least one processor of an electronic device to:
predict a question type for each section of a document using a trained question type prediction model, each section including a different portion of the document;
generate multiple question-answer pairs using a trained question-answer generation model that receives the predicted question types and the document as input, each question-answer pair comprising (i) a question having a type corresponding to one of the predicted question types and being associated with content in the section corresponding to the type and (ii) an answer to the question; and
output the question-answer pairs for use in training a question answering model.

18. The non-transitory machine-readable medium of claim 17, wherein:
the question type prediction model is trained to predict one or more question types for the document based on one or more entities described in the document; and
the non-transitory machine-readable medium further contains instructions that when executed cause the at least one processor to:
predict a question type for each of the one or more entities using the question type prediction model;
input the document and the question type for each of the one or more entities to the question-answer generation model; and
generate multiple additional question-answer pairs using the question-answer generation model.

19. The non-transitory machine-readable medium of claim 17, wherein:
the question type prediction model is trained to output a list of possible question types for possible combinations of section and entity for the document; and
the instructions that when executed cause the at least one processor to generate the multiple question-answer pairs using the trained question-answer generation model comprise:
instructions that when executed cause the at least one processor to generate at least one question-answer pair for each of the possible combinations.

20. The non-transitory machine-readable medium of claim 17, further containing instructions that when executed cause the at least one processor to:
compare the question-answer pairs to each other to determine any duplicate question-answer pairs; and
remove one or more duplicate question-answer pairs before outputting the question-answer pairs.
